(19) United States
(12) Patent Application Publication
(10) Pub. No.: US 2014/0304497 A1
(43) Pub. Date: Oct. 9, 2014

(54) ELECTRONIC DEVICE HAVING FUNCTION OF BOOTING OPERATING SYSTEM BY BOOTLOADER, METHOD OF PERFORMING THE SAME FUNCTION, AND STORAGE MEDIUM

(71) Applicant: Samsung Electronics Co., Ltd., Gyeonggi-do (KR)

(72) Inventor: Kyung-Min Park, Seoul (KR)

(73) Assignee: Samsung Electronics Co., Ltd., Gyeonggi-do (KR)

(21) Appl. No.: 14/245,928

(22) Filed: Apr. 4, 2014

(30) Foreign Application Priority Data
Apr. 5, 2013 (KR) 10-2013-0037757

(51) Int. Cl. G06F 9/44

(52) U.S. Cl. CPC G06F 9/4406
USPC 713/2

(57) ABSTRACT

An electronic device configured to perform a function of booting an operating system by a bootloader which boots the operating system by loading the bootloader on a memory, a method of performing the same function, and a storage medium. The electronic device includes: a first memory including a boot partition region for storing at least one piece of bootloader data including the function of booting the operating system, and a user partition region for copying and storing at least some bootloader data among entire bootloader data stored in the boot partition region; and a controller that loads initial program loader data stored in the boot partition region of the first memory to a second memory to execute the loaded initial program loader data, and loads the at least some bootloader data copied in the user partition region of the first memory to the second memory and executes the loaded bootloader data according to execution of the initial program loader data.

### PRIORITY

The present application is related to and claims the priority under 35 U.S.C. §119(a) to Korean Application Serial No. 10-2013-0037757, which was filed in the Korean Intellectual Property Office on Apr. 5, 2013, the entire content of which is hereby incorporated by reference.

### TECHNICAL FIELD

The present disclosure relates to an electronic device, and more particularly, to an electronic device configured to perform a function of booting an operating system by a bootloader which boots the operating system by loading the bootloader on a memory, a method of performing the same function, and a storage medium.

### BACKGROUND

As hardware functions of an electronic device, such as a computer, have varied, an Operating System (OS) has been developed in tandem. Accordingly, the operating system is implemented in a form capable of providing various functions and performing various application programs, but the capacity requirements of the operating system has excessively increased due to complex function. Accordingly, a problem in that a long period of time is taken to execute the operating system by simultaneously booting and executing a kernel. In order to solve the aforementioned problem, an electronic device, such as a smart phone, a PDA, and Internet home appliances, has recently and mainly adopted a system based on an embedded operating system, in which the operating system is not fetched from a disk, like a computer, but instead an operating system is stored in a separate chip to be embedded in the electronic device.

The importance of a storage medium is increased in a mobile device, such as a smart phone, and thus a storage capacity of the storage medium has been increased. Certain mobile devices use a memory, such as NOR, NAND, and OneNAND, but products employing an embedded Multi Media Card (eMMC) due to size and process have been recently released.

In a case where an operating system of an electronic device is booted by using the eMMC, a method of booting the operating system by a unique method for each a System On Chip (SOC) is provided. However, according to the Joint Electron Device Engineering Council (JEDEC) standard, a method of booting the operating system by using an image of a bootloader stored in a boot partition is suggested. The bootloader is a program for reading an operating system from an external memory unit and installing the read operating system in a main memory unit so as to enable a user to use an electronic device when the electronic device, such as a computer, is booted and started. When the bootloader fails to load an image stored in a flash/hard disk memory and the like in a memory, such as a Random Access Memory (RAM) and the like, a problem may occur in that the booting of the system fails or an operating system higher than the existing operating system needs to be installed again.

### SUMMARY

To address the above-discussed deficiencies, embodiments of the present disclosure provide an electronic device configured to perform a function of booting an operating system by a bootloader, which is capable of write protecting an image of a bootloader stored in a boot partition region, preventing the image of the bootloader from being damaged, and updating the image of the bootloader, a method of performing the same, and a storage medium.

Certain embodiments of the present disclosure include an electronic device configured to perform a function of booting an operating system by a bootloader, which is capable of updating an image of the bootloader and preventing an original image of the bootloader from being damaged by copying and storing the image of the bootloader in a separate user partition region, and executing a booting process through the stored image of the bootloader. Certain embodiments of the present disclosure include a method of performing the same, and a storage medium.

Certain embodiments of the present disclosure include an electronic apparatus configured to perform a function of booting an operating system by a bootloader. The electronic apparatus includes: a first memory including a boot partition region for storing at least one piece of bootloader data including the function of booting the operating system, and a user partition region for copying and storing at least some bootloader data among entire bootloader data stored in the boot partition region; and a controller that loads initial program loader data stored in the boot partition region of the first memory to a second memory to execute the loaded initial program loader data, and loads the at least some bootloader data copied in the user partition region of the first memory to the second memory and executes the loaded bootloader data according to execution of the initial program loader data.

The boot partition region of the first memory may be set to be write protected, so that a correction of the data may be restricted.

When a booting process by the bootloader data copied in the user partition region is not performed normally according to the execution of the initial program loader data, the second memory may load and execute corresponding bootloader data stored in the boot partition region of the first memory.

When the booting process is not performed normally, the initial program loader data can be set to be in a restore mode, and the first memory may restore the bootloader data stored in the user partition region from the bootloader data stored in the boot partition region of the first memory.

The second memory may execute the booting process again by loading the restored bootloader data stored in the user partition region of the first memory.

The first memory may be an embedded Multi Media Card (eMMC).

The bootloader data stored in the boot partition region may include: sub bootloader data for performing booting operations dependent on a System On Chip (SOC) or a board; and main bootloader data for performing booting operations independent from the SOC or the board.

The electronic apparatus may further include a third memory. When the sub bootloader data is loaded to the second memory to be executed normally, the main bootloader data may be loaded to a third memory to be executed.

Certain embodiments of the present disclosure include a method of booting an operating system by using bootloader data stored in a boot partition region of a first memory. The method includes: loading initial program loader data stored in the boot partition region to a second memory and executing the loaded initial program loader data; and loading at least some bootloader data copied in a user partition region of the first memory in the second memory and executing the loaded some bootloader data according to execution of the initial program loader data.

The boot partition region of the first memory may be set to be write protected, so that a correction of the data may be restricted.

The method may further include when a booting process by the bootloader data copied in the user partition region according to the execution of the initial program loader data is not performed normally, loading corresponding bootloader data stored in the boot partition region of the first memory to the second memory and executing the loaded bootloader data.

When the booting process is not performed normally, the initial program loader data may be set to be in a restore mode, and the first memory may restore the bootloader data stored in the user partition region from the bootloader data stored in the boot partition region of the first memory.

The first memory may execute the booting process again by loading the restored bootloader data stored in the user partition region of the first memory to the second memory.

The first memory may be an embedded Multi Media Card (eMMC).

The bootloader data stored in the image partition region may include a: sub bootloader data for performing booting operations dependent on a System On Chip (SOC) or a board; and main bootloader data for performing booting operations independent from the SOC or the board.

When the sub bootloader data is loaded to the second memory to be executed normally, the first memory may load the main bootloader data to the third memory and executes the loaded main bootloader data.

Certain embodiments of the present disclosure include a storage medium storing a program. The program includes: a boot partition region storing at least one piece of bootloader data including a function of booting an operating system; and a user partition region copying and storing at least some bootloader data among entire bootloader data stored in the boot partition region, wherein initial program loader data stored in the boot partition region is loaded to a separate memory to be executed, and at least some bootloader data copied in the user partition region is loaded to the separate memory to be executed according to the execution of the initial program loader data.

The boot partition region may be write protected, so that a data correction may be restricted.

When a booting process by the bootloader data copied in the user partition region is not performed normally according to the execution of the initial program loader data, corresponding bootloader data stored in the boot partition region of the first memory may be loaded to the separate memory to be executed.

When the booting process is not performed normally, the initial program loader data may be set to be in a restore mode, and the bootloader data stored in the user partition region is restored from the bootloader data stored in the boot partition region.

The restored bootloader data stored in the user partition region of the first memory may be loaded to the second memory to re-execute a booting process.

The storage medium may be an embedded Multi Media Card (eMMC).

The bootloader data stored in the boot partition region may include: sub bootloader data for performing booting operations dependent on a System On Chip (SOC) or a board, and main bootloader data for performing booting operations independent from the SOC or the board.

When the sub bootloader data may be loaded to the separate second memory and is executed normally, the main bootloader data is loaded to a third memory to be executed.

Information about the method of booting the operating system by the bootloader may be stored in a computer readable recording medium.

The recording medium includes all types of recording media in which a program and data are stored so as to be readable by a computer system. Examples of the recording medium include Read Only Memory (ROM), Random Access Memory (RAM), Compact Disk (CD), a Digital Video Disk (DVD)-Rom, magnetic tape, floppy disk, optical data storage device, and an embedded Multi Media Card (eMMC), and recording media such as carrier waves (e.g., transmission through the Internet). Further, the recording medium is distributed to computer systems connected through a network, so that a computer readable code can be stored and executed by a distribution method.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure for booting an operating system by a bootloader according to the present disclosure;

FIG. 2 illustrates a booting process of an operating system by a bootloader according to the present disclosure;

FIG. 3 illustrates a structure for booting an operating system by a bootloader according to embodiments of the present disclosure;

FIG. 4 illustrates a structure of booting the operating system by the bootloader in a normal state according to embodiments of the present disclosure;

FIG. 5 illustrates a structure of booting the operating system by the bootloader when an error is generated according to embodiments of the present disclosure;

FIG. 6 illustrates a structure of restoring a user partition region when an error is generated according to embodiments of the present disclosure;

FIG. 7 illustrates a method of booting an operating system by a bootloader according to embodiments of the present disclosure;

FIG. 8 illustrates a method of booting an operating system by a bootloader according to embodiments of the present disclosure;

FIG. 9 illustrates a method of booting an operating system by a bootloader according to embodiments of the present disclosure; and

FIG. 10 illustrates an example in which embodiments of the present disclosure are applied to an embedded Multi Media Card.

### DETAILED DESCRIPTION

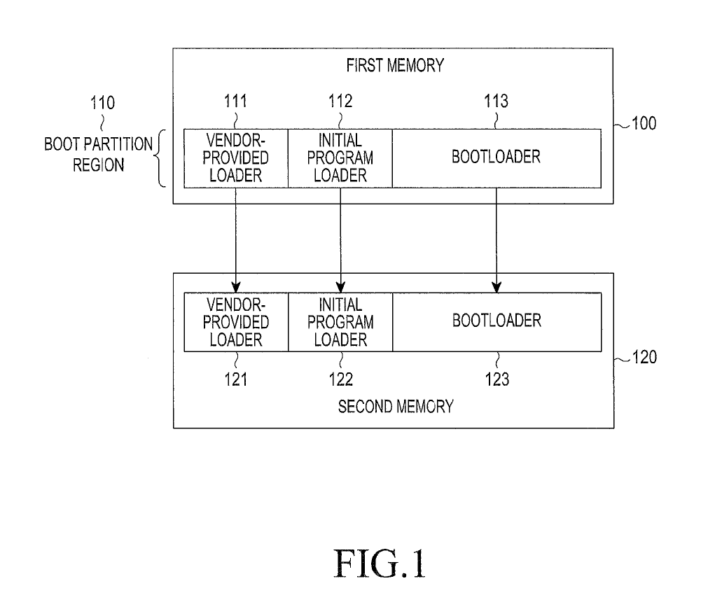

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless electronic device or system. The present disclosure will be described with reference to the accompanying drawings based on a specific embodiment in which the present disclosure may be carried out as an example. The embodiments will be sufficiently described in detail so that those skilled in the art may carry out the present disclosure. It should be understood that various embodiments of the present disclosure are different from each other, but need not be mutually exclusive. For example, a specific figure, a structure, and a characteristic described herein may be implemented as another embodiment without departing from a spirit and a scope of the present disclosure in relation to an embodiment. Further, it should be understood that a position or a displacement of an individual constituent element in each disclosed embodiment may be changed without departing from the spirit and the scope of the present disclosure. Accordingly, a detailed description below should not be taken as a limited meaning, and will be defined by the accompanying claims together with all equivalent scopes to the claims if the scope of the present disclosure is appropriately described. Like reference numerals in the drawing denote the same or similar function throughout several embodiments.

FIG. 1 illustrates a structure of booting an operating system by a bootloader according to the present disclosure. Referring to FIG. 1, when an electronic device is booted, respective bootloaders 111 through 113 stored in a boot partition region 110 of a first memory 100 (e.g., an eMMC) are loaded on a second memory 120 (e.g., a RAM) according to a request of an Application Processor (AP), and respective bootloaders 121 through 123 loaded on the second memory 120 are executed to perform a booting process.

The bootloader executes a function, such as setting hardware, and the like, necessary for the booting through one binary number, and is used for loading a kernel image. However, in addition to the booting through the one binary number, due to an issue, such as of security and a structural issue of hardware, as illustrated in FIG. 1, the entire bootloader is divided and used according to a use.

For example, in a case of a system Large Scale Integration (LSI) chip, in order to provide secure booting, several classified bootloaders, such as a vendor-provided loader 111, the entire bootloaders being provided by a chip vendor, an Initial Program Loader (IPL) 112, and a bootloader 113, are used.

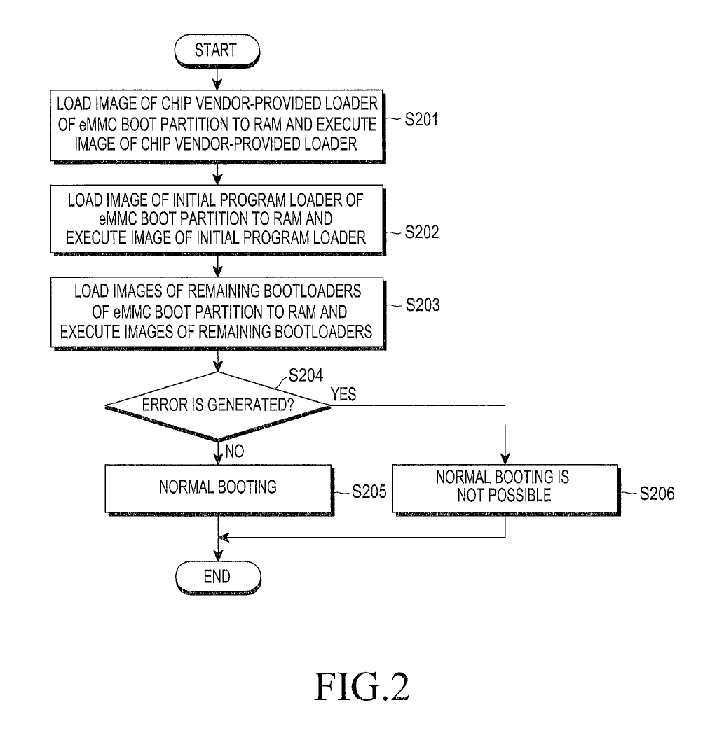

FIG. 2 illustrates a booting process of an operating system by a bootloader according to the present disclosure. Referring to FIG. 2, first, in block S201, an image of the vendor-provided loader 111 recorded in the boot partition region 110 of the first memory 100 (e.g., the eMMC) is loaded on the second memory 120 to be executed according to an operation of the AP. Then, in block S202, an image of the IPL 112 recorded in the boot partition region 110 of the first memory 100 is loaded on the second memory 120 to be executed according to the execution of the vendor-provided loader 121 loaded in the second memory 120. In block S203, an image of the remaining bootloader 113 recorded in the boot partition region 110 of the first memory is loaded on the second memory 120 to be executed, so that a normal booting process is performed in block S205.

In this case, the boot partition region 110 of the first memory 100 is set to be in a writable state, not a write protected state, for updating the image of the bootloader. However, due to this, the image of the bootloader is vulnerable to damage from various sources.

When the image of the bootloader is damaged as described above and incurs an error in block S204, the normal booting process fails to be performed in block S206, so that the booting is not fundamentally performed, and there is no way to restore the image of the bootloader.

In a case where a hardware (HW) protection function (e.g., a write protection function) is utilized in the aforementioned bootloader structure, a problem may occur in which the booting fails due to erasing or damage of the bootloader. However, in actuality, in a case where a correction and the like is generated when a bug of the bootloader 113 is corrected, the memory is initialized, and a clock is initialized, a problem occurs, in that it is impossible to correct the bootloader due to the hardware protection function, and thus it is not preferable to use the hardware protection function.

Further, in addition to the hardware protection function, various methods, such as power-on protection and permanent protection, are provided. In a case of the power-on protection, the kernel turns off power in a sleep mode due to a current consumption issue, so that the protection is released and cannot be used. Further, in a case of the permanent protection, when the protection is performed once, updating is no longer possible.

Accordingly, a method capable of protecting an image of a bootloader stored in a boot partition region and simultaneously updating the bootloader has been demanded. Further, a method capable of normally performing booting even in a case where the image of the bootloader is damaged due to various reasons, and effectively restoring the damaged image of the bootloader is demanded.

The present disclosure discloses an electronic device configured to perform a function of booting an operating system by a bootloader for booting the operating system by loading the bootloader stored in a memory, a method of performing the same, and a storage medium. To this end, in the embodiments of the present disclosure, an image of a bootloader stored in a boot partition region within a memory is copied into a user partition region to be used. Accordingly, booting is performed by loading the image of the bootloader copied into the user partition region in a normal state. If the image of the bootloader copied into the user partition region is damaged or the bootloader is not operated normally due to misuse by a user or a system, the booting may be performed by loading an original image of the bootloader stored in the boot partition region, or the normal booting may be performed by restoring the image of the bootloader of the user partition region from the original image of the bootloader.

In this case, the boot partition region in which the original image of the bootloader is stored according to the embodiments of the present disclosure may be set to be write protected. Accordingly, the original image of the bootloader is not damaged, so the original image of the bootloader will be restored when the image of the bootloader copied into the user partition region is damaged. Accordingly, a situation where the normal booting is not executed due to the damage of the bootloader is fundamentally prevented.

The term “bootloader’ used in the present disclosure is a program for reading an operating system from a specific storage medium (e.g., an external memory unit) and installing the read operating system in a main memory unit (e.g., a RAM) so as to enable a user to use an electronic device when the user boots or start the electronic device. Accordingly, the storage medium in which the image of the bootloader is stored according to the embodiment of the present disclosure is not limited to a specific type of a specific form of storage medium.

Further, in the description below, for helping the understanding, the bootloader may be referred to by various specific terms (e.g., a vendor-provided loader, an Initial Program Loader (IPL), a sub bootloader, a main bootloader, BL1, s-boot, tzsw, and u-boot), but the present disclosure is not limited thereto, and any data capable of performing the aforementioned function of the bootloader may be used as the bootloader according to the embodiment of the present disclosure.

Hereinafter, the embodiments of the present disclosure will be described with reference to the accompanying drawings in detail so that those skilled in the art may easily carry out the present disclosure.

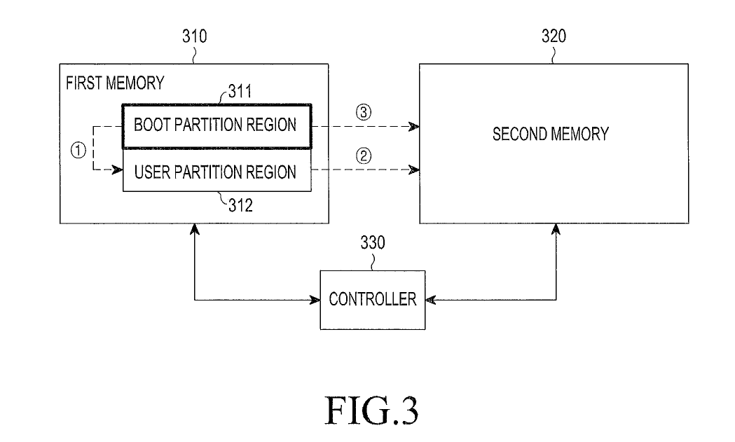

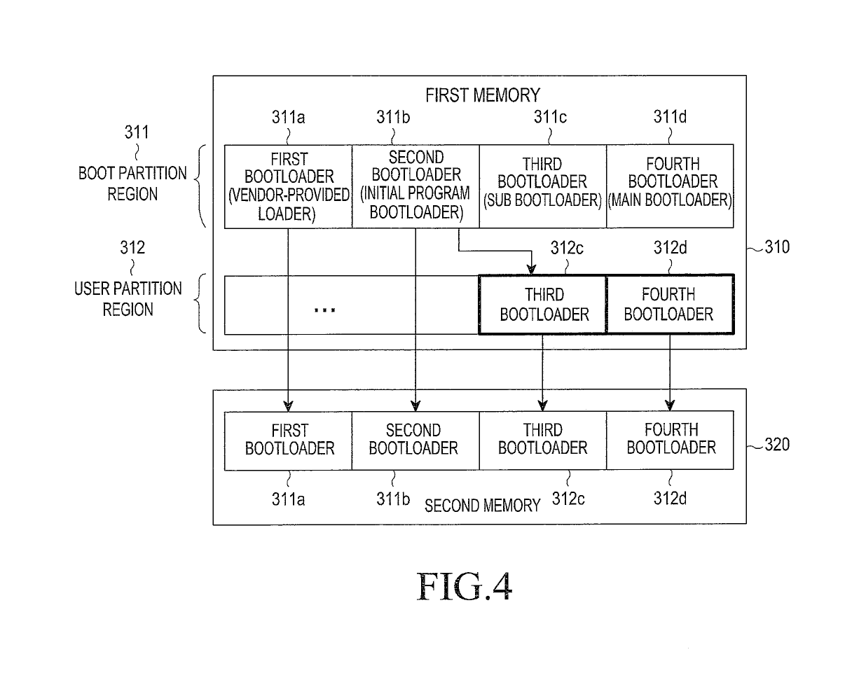

First, a structure of an operating system booting system using the bootloader according to the embodiment of the present disclosure will be first described with reference to FIG. 3, and then an apparatus and a method according to the embodiment of the present disclosure will be described in detail with reference to FIGS. 4 through 9.

FIG. 3 illustrates a structure of booting an operating system by a bootloader according to embodiments of the present disclosure. Referring to FIG. 3, the operating system booting system using the bootloader according to the embodiment of the present disclosure includes a first memory 310, a second memory 320, and a controller 330. When power of an electronic device is turned on or booting thereof is requested, the controller 330 performs a booting process by loading an image of the bootloader stored in the first memory 310 to a second memory 320 and executing the loaded image of the bootloader.

In this case, according to the embodiment of the present disclosure, the first memory 310 includes a plurality of regions divided into a boot partition region 311 and a user partition region 312, and an original image of the bootloader is stored in the boot partition region 311. Further, the entire or at least partial images of the original images of the bootloaders stored in the boot partition region 311 may be equally copied into and stored in the user partition region 312.

When the booting is started, the controller 330 executes at least a partial bootloader among the bootloaders stored in the boot partition region 311 of the first memory 310 (\textcircled{1}), and images of the remaining bootloaders stored in the user partition region are loaded to the second memory 320 (\textcircled{2}) to be executed according to the execution of the bootloader.

In the meantime, in a case where the normal booting process is not performed because the image of the bootloader stored in the user partition region 312 is damaged or has a problem, the image of the bootloader stored in the boot partition region 311 is loaded to the second memory 320 (\textcircled{3}) to be executed. In this case, according to the embodiment of the present disclosure, the boot partition region 311 is set to be write protected, so that the image of the bootloader stored in the boot partition region 311 may be protected even though the image of the bootloader stored in the user partition region 312 is damaged. Further, according to the embodiment of the present disclosure, in a case where the image of the bootloader stored in the user partition region 312 is damaged, the image of the bootloader stored in the user partition region 212 may be restored by a corresponding image of the bootloader stored in the boot partition region 311. Further, the user partition region 312 is not set to be write protected, so that it is possible to update the image of the bootloader, and the booting process may be performed with the updated image of the bootloader in a normal situation.

In the meantime, according to various embodiments of the present disclosure, in a case where the normal booting process is not executed because the image of the bootloader stored in the user partition region 312 is damaged, the booting process may be performed normally by loading the image of the bootloader stored in the boot partition region 311 to the second memory 320 as described above. In certain embodiments, the booting process may also be performed by loading the restored image of the bootloader stored in the user partition region 312 to the second memory 320 after the damaged image of the bootloader stored in the user partition region 312 is first restored with the image of the bootloader stored in the boot partition region 311.

The system according to the embodiments of the present disclosure illustrated in FIG. 3 may be applied to any type of electronic device which boots an operating system by using a bootloader, and may be applied to an embedded operating system based system, in which an operating system is stored in a separate chip and embedded in a device, such as a smart phone, a PDA, and Internet home appliances.

As described above, when the system according to the embodiment of the present disclosure may be applied to the embedded operating system based system, the controller 330 is an Application Processor (AP), the first memory 310 may be a storage media, such as the eMMC, and the second memory 320 may be a storage medium, such as a RAM.

Hereinafter, a more detailed embodiment of the system aforementioned in FIG. 3 will be described with reference to FIG. 4 through 6. A term (e.g., a detailed type of bootloader) used in the embodiment to be described below may be a more particular term used for helping the understanding of the present disclosure, but the present disclosure is not limited to a corresponding term.

FIG. 4 illustrates a structure of booting the operating system by the bootloader in a normal state according to the embodiments of the present disclosure. Referring to FIG. 4, the first memory 310 may be divided into the boot partition region 311 and the user partition region 312 according to the embodiment of the present disclosure. The boot partition region 311 may include a first bootloader 311a, a second bootloader 311b, a third bootloader 311c, a fourth bootloader 311d, and the like. In the meantime, the configuration of the bootloader of FIG. 4 may be variously formed according the embodiment of the present disclosure, and at least two bootloaders may be formed as one bootloader according to certain implementations.

For example, the first bootloader 311a may be a vendor-provided loader provided by a chip vendor, and the second bootloader 311b may be an Initial Program Loader (IPL). Further, the third bootloader 311c and the fourth bootloader 311d may further include images of the remaining bootloaders. For example, the third bootloader 311c may serve as a sub bootloader for performing operations (e.g., memory initialization, and clock initialization) dependent on a System on Chip (SOC) or a board, and the fourth bootloader 311d may serve as a main bootloader for performing operations (e.g., driver initialization, screen initialization, a USB downloading function, and a charging function) independent on the SOC or the board. Accordingly, the third bootloader 311c and the fourth bootloader 311d may also be formed as one bootloader according to another embodiment of the present disclosure.

According to the embodiments of the present disclosure, the images of the entire bootloaders or at least some bootloaders among a plurality of bootloaders included in the boot partition region 311 may be copied into the user partition region 312 to be stored. According to the embodiments of the present disclosure, FIG. 4 illustrates an example in which the third bootloader 312c and the fourth bootloader 312d are copied and stored.

Accordingly, when the booting is started, the first bootloader 311a within the boot partition region 311 is loaded to the second memory 320 to be executed according to a booting initialization of the AP. Further, the second bootloader 311b is loaded to the second memory 320 to be executed according to the execution of the first bootloader 311a. In this case, in the embodiment of the present disclosure, according to the execution of the second bootloader 311b, the third bootloader 311c or the fourth bootloader 311d within the boot partition region 311 are not loaded to the second memory 310, but the third bootloader 312c or the fourth bootloader 312d copied into the user partition region 312 are loaded to the second memory 310 to be executed. For example, in the embodiments of the present disclosure, the bootloader stored in the boot partition region 310 of the first memory 311 is not loaded to the second memory 320 to be executed, but the entire or at least partial copied bootloaders within the user partition region 312 of the first memory 311 are loaded to the second memory 320 to be executed. In certain embodiments, as illustrated, the initial program loader 311b is loaded to the second memory 320 from the boot partition region 311 of the first memory 310, and the remaining bootloaders (e.g., the sub bootloader or the main bootloader) are loaded to the second memory 320 from the user partition region 312 of the first memory 310 to be executed.

The second bootloader 311b, which is the initial program loader, is configured to read an image of the third bootloader 312c stored in the user partition region 312 and load the read image of the third bootloader 312c to the second memory 320 (e.g., an internal RAM).

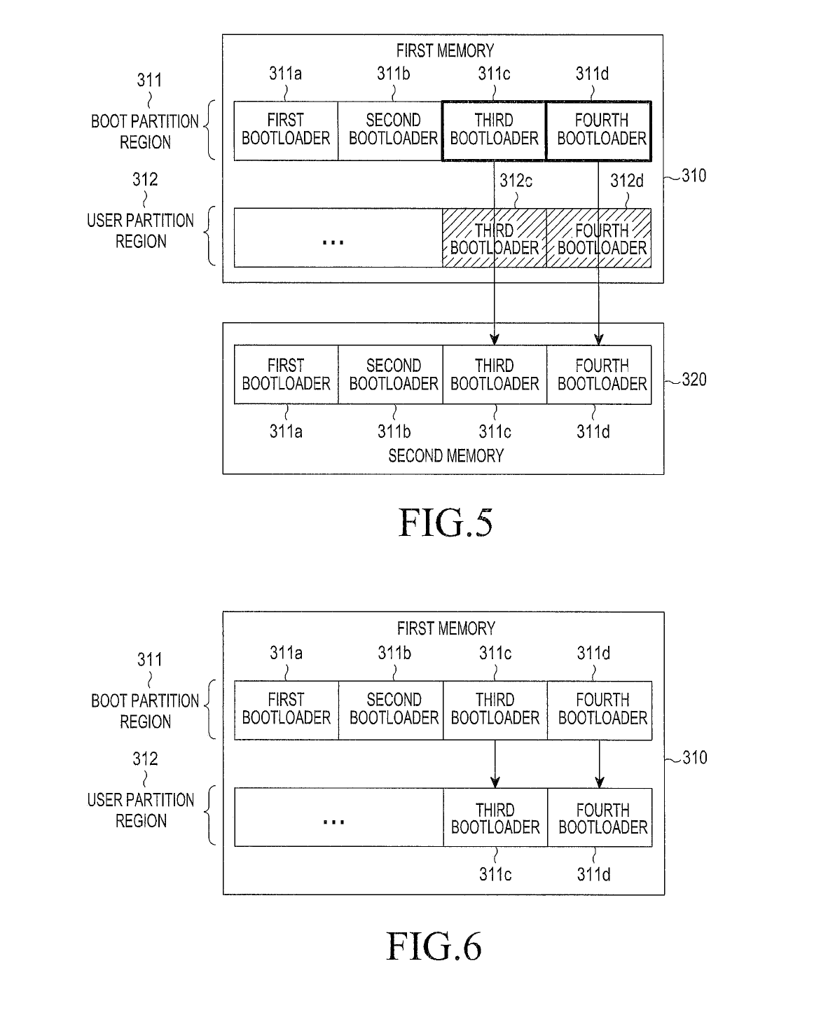

In this case, when the loaded third bootloader 312c or fourth bootloader 312d is not executed normally, the image of the third bootloader 311c or the fourth bootloader 312d stored in the boot partition region 311 is read, is loaded to the second memory 320, and then executed as illustrated in FIG. 5.

FIG. 5 illustrates a structure of booting the operating system by the bootloader when an error is generated according to the embodiments of the present disclosure. Referring to FIG. 5, when it is determined that the third bootloader 312c loaded to the second memory is not executed normally in the second bootloader 311b (e.g., by a method, such as watchdog), the image of the third bootloader 311c or the fourth bootloader 311d stored in the boot partition region 311 is read, is loaded to the second memory 320, and then executed as illustrated. In this case, the second bootloader 311 may notify of a restore mode by using a method, such as a restore flag. In the meantime, the method of setting the restore mode may include a method utilizing a specific address of the RAM, and may also include a method using one sector of the eMMC. Further, similarly, a method of identifying whether the normal booting is performed may adopt a method, such as signature and watchdog reset.

Accordingly, even though the booting is not normally performed even though the bootloaders stored in the user partition region 312 are damaged, the original bootloaders stored in the boot partition region 311 are not damaged, so that normal booting is available. Further, booting in the normal situation is performed by the bootloaders stored in the user partition region 312, so that the bootloaders stored in the boot partition region 311 are write protected, thereby fundamentally preventing the original bootloader from being damaged. Further, even though the bootloaders stored in the boot partition region 311 are write protected, the bootloaders stored in the user partition region 312 may be modified or corrected, so that it is possible to perform operations, such as bug correction of the bootloader, and correction at the memory initialization and the clock initialization.

Although not illustrated in FIGS. 4 and 5, the third bootloader 311c or 312c is loaded to the second memory 320, such as the internal RAM, and the fourth bootloader 311d or 312d is loaded to a separate third memory (not illustrated), such as a DRAM, so that the third bootloader 311c or 312c and the fourth bootloader 311d or 312d may be executed. In this case, since the operation dependent on the board, such as the memory initialization, is executed by the third bootloader 311c or 312c, the memory, such as the DRAM, is not normally operated before the third bootloader 311c or 312c is not executed normally, so that the third bootloader 311c or 312c is not directly loaded to the DRAM, and the like.

FIG. 6 illustrates a structure of restoring the user partition region when an error is generated according to the embodiments of the present disclosure. Referring to FIG. 6, when the bootloaders stored in the user partition region 312 are damaged as illustrated in FIG. 5, the damaged bootloaders of the user partition region may be restored by the corresponding bootloaders stored in the boot partition region 311.

The respective constituent elements of the apparatus are separately indicated in the drawing so as to represent that the respective constituent elements of the apparatus may be functionally and logically separated, and this does not mean that the respective constituent elements of the apparatus are essentially implemented as separate constituent elements or separate codes.

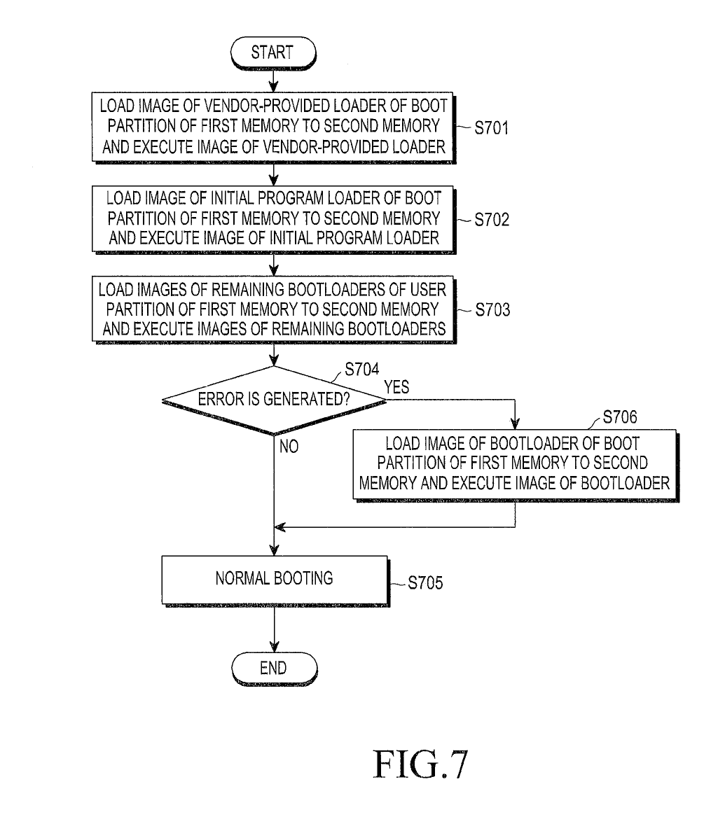

Hereinafter, a process of booting the operating system by the bootloader according to various embodiments of the present disclosure will be described in detail with reference to FIGS. 7 through 9.

FIG. 7 illustrates a process of booting the operating system by a bootloader according to embodiments of the present disclosure. Referring to FIG. 7, when booting is initiated as described above, an image of a chip vendor-provided loader of the boot partition region of the first memory is loaded to the second memory to be executed in block S701. Then, in block S702, an image of an Initial Program Loader of the boot partition region of the first memory is loaded to the second memory to be executed. Next, in block S703, images of the remaining bootloaders of the user partition region of the first memory are loaded to the second memory to be executed according to the embodiments of the present disclosure. Accordingly, in block S705, the normal booting process is performed according to the execution of the image of the bootloader of the user partition region of the first memory.

In this case, in block S704, when an error is generated because the image of the bootloader of the user partition region of the first memory is damaged or the normal booting process is not performed, the process moves to block S706, and an image of a bootloader of the boot partition region of the first memory (e.g., the image of the original bootloader) is loaded to the second memory to be executed, thereby performing the normal booting process according to the embodiment of the present disclosure.

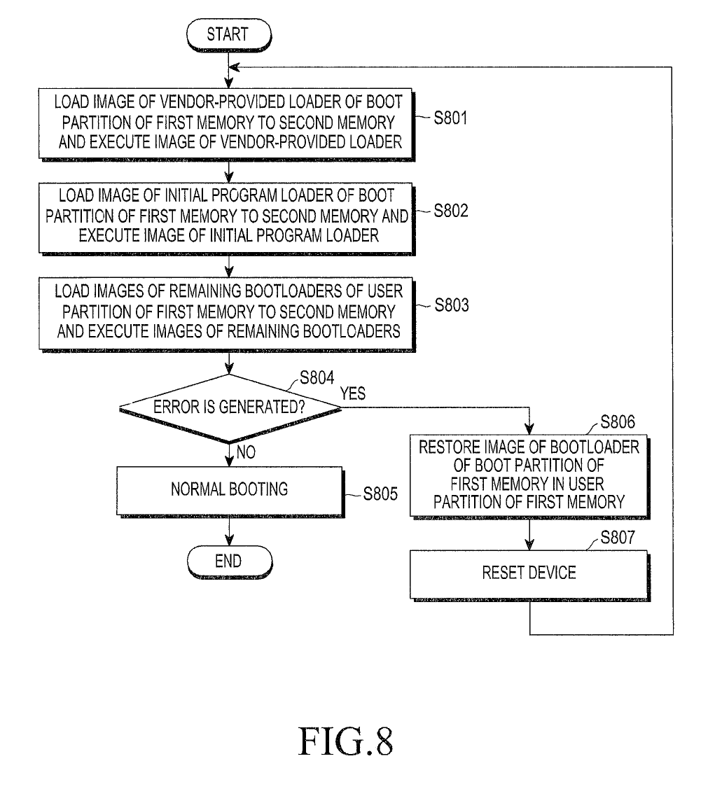

FIG. 8 illustrates a process of booting the operating system by a bootloader according to embodiments of the present disclosure. Referring to FIG. 8, when booting is initiated as described above, an image of a chip vendor-provided loader of the boot partition region of the first memory is loaded to the second memory to be executed in block S801. Then, an image of an Initial Program Loader of the boot partition region of the first memory is loaded to the second memory to be executed (S802). Next, images of the remaining bootloaders of the user partition region of the first memory are loaded to the second memory to be executed in block S803 according to the embodiments of the present disclosure. Accordingly, the normal booting process is performed according to the execution of the image of the bootloader of the user partition region of the first memory in block S805.

In this case, when an error is generated because the image of the bootloader of the user partition region of the first memory is damaged or the normal booting process is not performed in block S804, the process moves to block S806, and the image of the damaged bootloader of the user partition region of the memory is restored by using the image of the bootloader of the boot partition region of the first memory (e.g., an image of an original bootloader) (S806) according to embodiments of the present disclosure. Then, when the apparatus is reset in block S807, the loading process of the bootloader is performed again, and the normal booting process may be performed by the image of the restored bootloader of the user partition region.

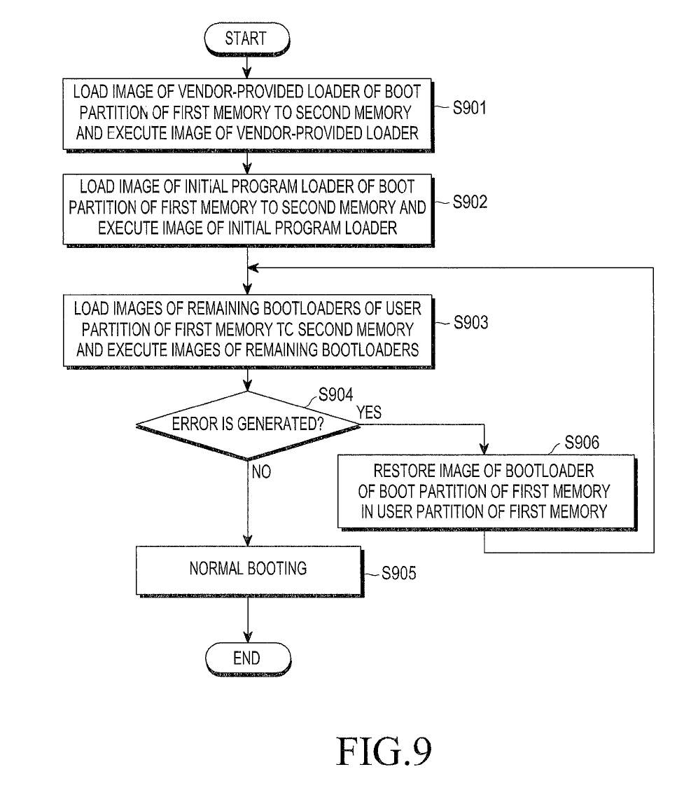

FIG. 9 illustrates a process of booting the operating system by a bootloader according to embodiments of the present disclosure. Referring to FIG. 9, when booting is initiated as described above, an image of a chip vendor-provided loader of the boot partition region of the first memory is loaded to the second memory to be executed in block S901. Then, an image of the initial program loader of the boot partition region of the first memory is loaded to the second memory to be executed in block S902. Next, in block S903, images of the remaining bootloaders of the user partition region of the first memory are loaded to the second memory to be executed according to the embodiments of the present disclosure. Accordingly, the normal booting process is performed according to the execution of the image of the bootloader of the user partition region of the first memory in block S905.

In this embodiment, when an error is generated because the image of the bootloader of the user partition region of the first memory is damaged or the normal booting process is not performed in block S904, the process moves to block S906, and the image of the damaged bootloader of the user partition region of the memory is restored by using the image of the bootloader of the boot partition region of the first memory (e.g., an original image of the bootloader) according to the embodiments of the present disclosure. Then, the normal booting process performed by the image of the restored bootloader of the user partition region.

Hereinafter, the operating system booting method by the bootloader according to the embodiments of the present disclosure may be implemented in a program command form executable by various computer means and recorded in a computer readable medium. The computer readable medium may include one or a combination of a program command, a data file, and a data structure. The program command recorded in the computer readable medium may be specially designed and configured for the present disclosure, or may be publicly known to and used by those skilled in the computer software field. An example of the computer readable recording medium includes a magnetic media, such as a hard disk, a floppy disk, and a magnetic tape, an optical media, such as a CD-ROM and a DVD, a magneto-optical media, such as a floptical disk, and a hardware device, such as a ROM, a RAM, a flash memory, and the eMMC, specially formed to store and execute a program command. An example of the program command includes a high-level language code executable by a computer by using an interpreter, and the like, as well as a machine language code created by a compiler. The hardware device may be configured to be operated with one or more software modules in order to perform the operation of the present disclosure, and an opposite situation thereof is also possible.

### Embodiment

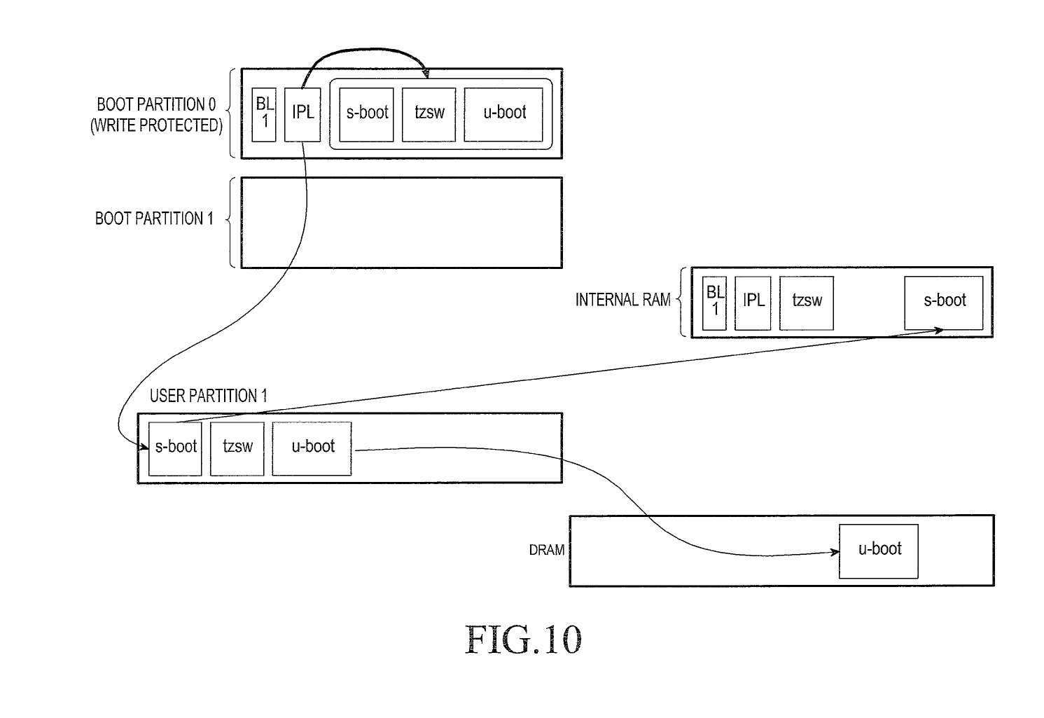

FIG. 10 illustrates an example in which the embodiments of the present disclosure are applied to the eMMC. Referring to FIG. 10, an operating system booting process using the bootloader may be performed by loading a bootloader stored in the eMMC to an internal RAM and executing the loaded bootloader.

For example, a plurality of bootloaders, such as “BL1”, “IPL”, “s-boot”, “tzsw”, and “u-boot”, are stored in a region of boot partition 0 1010, and the region of boot partition 0 1010 is set to be write protected and not to be corrected.

“BL1” 1010a represents the vendor-provided loader among the aforementioned bootloaders, and “IPL” 1010b represents the Initial Program Loader, “s-boot” 1010c represents the sub bootloader, and “u-boot” 1010e represents the main bootloader. Further, “tzsw”, which is an image for a “TrustZone” 1010d represents to a bootloader dependent on the board, and may be selectively added.

As described above, when the booting is started according to the embodiments of the present disclosure, the “BL1” 1010a and the “IPL” 1010b of the region of boot partition 0 1010 are loaded in the internal RAM 1030 to be executed. In this case, the “IPL” 1010b, which is a default setting value, is set so as to load an image of “s-boot” 1020c in the user partition 1020 to the internal RAM 1030 to be executed according to the embodiments of the present disclosure. Accordingly, the image of “s-boot” 1020c within the user partition region 1020 is loaded to the internal RAM 1030 to be executed according to the execution of “IPL.” In this case, when it is determined that “s-boot” is not normally performed in the “IPL”, the mode is switched to the restore mode, and according to the setting of the restore mode, the image of “s-boot” of the region of boot partition 0 1010 is loaded to the internal RAM 1030 to perform the booting process.

Accordingly, even though the normal booting process is not performed due to damage of the image of “s-boot” 1020c of the user partition region 1020, the normal booting process is performed by using the image of “s-boot” of the boot partition region.

As described above, when the image of “s-boot” is loaded to the internal RAM 1030 to be performed normally, the DRAM 1040 is operated normally, and then an image of “u-boot” 1020e of the user partition region is loaded to the DRAM 1040 to be executed.

As described above, according to the embodiments of the present disclosure, the image of the bootloader stored in the boot partition region of the memory is write protected, so as to prevent the image of the bootloader from being damaged. Accordingly, it is possible to fundamentally prevent a situation where the normal booting is not performed due to the damage of the bootloader, and the normal booting is performed in either cases.

Further, according to the embodiments of the present disclosure, the image of the bootloader may be updated by copying the image of the bootloader stored in the boot partition region into the user partition region 1020, and loading and using the image of the bootloader in the user partition region 1020 when the operating system is booted. In this case, even though the image of the bootloader 1020a-c in the user partition region 1020 is damaged, the damaged image of the bootloader may be restored with the image of the bootloader stored in the boot partition region, so that it is possible to perform the normal booting.

For example, in a case where a problem is generated in the bootloader after the release of an electronic apparatus, if only the images of the bootloaders included in the user partition region are updated, the normal booting is available, so that it is possible to solve the problems referenced to FIGS. 1 and 2, such as the problem of failure of booting due to the damage of the image of the bootloader.

Although the present disclosure has been described with examples, various changes and modifications may be suggested to one skilled in the art. It is intended that the present disclosure encompass such changes and modifications as fall within the scope of the appended

What is claimed is:

1. An electronic apparatus configured to perform a function of booting an operating system by a bootloader, the electronic apparatus comprising:
a first memory including:
a boot partition region configured to store at least one piece of bootloader data, the bootloader data including the function of booting the operating system, and
a user partition region configure to copy and store at least some bootloader data among entire bootloader data stored in the boot partition region; and
a controller configured to:
load initial program loader data stored in the boot partition region of the first memory to a second memory to execute the loaded initial program loader data,
load the at least some bootloader data copied in the user partition region of the first memory to the second memory, and
execute the loaded bootloader data according to execution of the initial program loader data.

2. The electronic apparatus of claim 1, wherein the boot partition region of the first memory is set to be write protected, wherein a correction of data stored in the boot partition region is restricted.

3. The electronic apparatus of claim 1, wherein the second memory is configured to load and execute corresponding bootloader data stored in the boot partition region of the first memory when a booting process by the bootloader data copied in the user partition region is not performed normally according to the execution of the initial program loader data.

4. The electronic apparatus of claim 3, wherein the initial program loader data is configured to be set in a restore mode when the booting process is not normally performed, and
the first memory is configured to restore the bootloader data stored in the user partition region from the bootloader data stored in the boot partition region of the first memory.

5. The electronic apparatus of claim 4, wherein the second memory is configured to execute the booting process again by loading the restored bootloader data stored in the user partition region of the first memory.

6. The electronic apparatus of claim 1, wherein the first memory is an embedded Multi Media Card (eMMC).

7. The electronic apparatus of claim 1, wherein the bootloader data stored in the boot partition region includes:
sub bootloader data configured to perform booting operations dependent on a System On Chip (SOC) or a board; and
main bootloader data configured to perform booting operations independent from the SOC or the board.

8. The electronic apparatus of claim 7, further comprising:
a third memory,
wherein when the sub bootloader data is configured to be loaded to the second memory and to be executed normally, and
wherein the main bootloader data is configured to be loaded to the third memory to be executed.

9. A method of booting an operating system by using bootloader data stored in a boot partition region of a first memory, the method comprising:
loading initial program loader data stored in the boot partition region to a second memory and executing the loaded initial program loader data;
loading at least some bootloader data copied in a user partition region of the first memory in the second memory; and
executing the loaded some bootloader data according to execution of the initial program loader data.

10. The method of claim 9, wherein the boot partition region of the first memory is set to be write protected, wherein a correction of the data stored in the boot partition region is restricted.

11. The method of claim 9, further comprising:
when a booting process by the bootloader data copied in the user partition region according to the execution of the initial program loader data is not normally performed, loading corresponding bootloader data stored in the boot partition region of the first memory to the second memory and executing the loaded bootloader data.

12. The method of claim 11, further comprising setting the initial program loader dated to a restore mode when the booting process is not performed normally, wherein the first memory is configured to restore the bootloader data stored in the user partition region from the bootloader data stored in the boot partition region of the first memory.

13. The method of claim 12, wherein the first memory is configured to execute the booting process again by loading the restored bootloader data stored in the user partition region of the first memory to the second memory.

14. The method of claim 9, wherein the first memory is an embedded Multi Media card (eMMC).

15. The method of claim 9, wherein the bootloader data stored in the image partition region includes:
sub bootloader data configured to perform booting operations dependent on a System On Chip (SOC) or a board; and
main bootloader data configured to perform booting operations independent from the SOC or the board.

16. The method of claim 15, wherein the first memory is configured to load the main bootloader data to the third memory and execute the loaded main bootloader data when the sub bootloader data is loaded to the second memory to be executed normally.

17. A storage medium comprising:
a boot partition region storing at least one piece of bootloader data and initial program loader data; and
a user partition region storing at least some bootloader data among entire bootloader data stored in the boot partition region,
the storage medium storing a program, the program comprising executable instructions that, when executed, cause processing circuitry to:
execute the at least one piece of bootloader data configured to perform a function of booting an operating system,
copy at least some bootloader data among entire bootloader data stored in the boot partition region to the user partition region,
load the initial program loader data to a separate memory to be executed, and
load at least some of the copied bootloader data in the user partition region to the separate memory to be executed according to the execution of the initial program loader data.

18. The storage medium of claim 17, wherein the boot partition region is write protected, wherein a data correction is restricted.

19. The storage medium of claim 17, wherein the program further comprises executable instructions that when executed cause processing circuitry to:
load bootloader data stored in the boot partition region of a first memory to the separate memory to be executed when a booting process by the bootloader data copied in the user partition region is not performed normally according to the execution of the initial program loader data.

20. The storage medium of claim 19, wherein the program further comprises executable instructions that when executed cause processing circuitry to:
set the initial program loader data to a restore mode when the booting process is not normally performed, and
restore the bootloader data stored in the user partition region from the bootloader data stored in the boot partition region.

21. The storage medium of claim 20, wherein the program further comprises executable instructions that when executed cause processing circuitry to:
load the restored bootloader data stored in the user partition region of the first memory to a second memory to re-execute a booting process.

22. The storage medium of claim 17, wherein the storage medium is an embedded Multi Media Card (eMMC).

23. The storage medium of claim 17, wherein the bootloader data stored in the boot partition region includes:
sub bootloader data including executable instructions that when executed by the processing circuitry perform booting operations dependent on one of: a System On Chip (SOC) and a board, and
main bootloader data including executable instructions that when executed by the processing circuitry perform booting operations independent from the one of: the SOC and the board.

24. The storage medium of claim 23, wherein the program further comprises executable instructions that when executed cause processing circuitry to:
load the main bootloader data to a third memory to be executed when the sub bootloader data is loaded to the separate second memory and is executed normally.
